(19) United States
(12) Patent Application Publication
(10) Pub. No.: US 2008/0250693 A1
(43) Pub. Date: Oct. 16, 2008

(54) Streamlined Counterbalanced Fishing Jig

(76) Inventor: George Raymond Krueger, Palmyra, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/734,322

(22) Filed: Apr. 12, 2007

(51) Int. Cl. A01K 85/00

(52) U.S. Cl. 43/42.39; 43/42.43

(57) ABSTRACT

A fishing jig includes a fish hook integral construction with a center axis having a hook curve trailing extremity with a hook point, and a straight hook shank extending forwardly from the hook curve. An eye bend extends forwardly and upwardly at an eye bend radius point at an angle of substantially 20° relative to the axis of the hook shank, and terminating in a line-attachment eye leading extremity. A weighted metal body is connected to and distributed symmetrically along the hook shank and the eye bend. The body has a mass distribution which is greater below the center axis of the hook than above the center axis of the hook by creating a wedge on a lower portion of the body that counterbalances weight of the hook curve and the hook point. A center of gravity is defined above the wedge at substantially the eye bend radius point such that the jig assumes an upright position in which the hook shank is maintained and has a substantially horizontal attitude. The hook point lies in an uppermost position relative to the hook shank such that the jig will not tumble, spiral or rotate when attached on a fishing line.

### FIELD OF THE INVENTION

This invention relates generally to metal-weighted fishing hooks commonly referred to as jigs.

### BACKGROUND OF THE INVENTION

Jigs are hooks with metal weight attached directly to the shank of the hook to provide the weight necessary to cast the lure.

Jigs have been used by anglers for many years, however, the introduction of light weight spinning reels, ultra sensitive rods and fine diameter lines offer a number of advantages as to how anglers fish jigs today.

Reels allow greater casting distances with lighter lures and a greater range of retrieval speeds. Ultra sensitive rods allow the angler to feel the lightest fish strikes or structure that the lure is being retrieved through. Ultra light fine diameter lines produce less line drag allowing longer casting distances and faster descent rates when the lure is in the water.

The advantage of the jig is its versatility. Its compact size to weight ratio provides a lure that casts easily. With natural material, such as feathers or hair dressings permanently attached to the body, it becomes a self-contained lure. Without permanent dressings, it can be combined with a number of interchangeable, rubberized elements specifically designed to be threaded to the hook. Finally, they can be used without dressings simply as a carrier of live bait threaded to the hook.

Whether a jig is being cast and retrieved, trolled or allowed to sink on a slack line, the most desirable presentation of the lure will be with the hook shank and body horizontal, and the hook bend or curve vertical with the point being the uppermost part. This desirable upright position increases the probability that when a fish strikes the lure, the point will be embedded in the upper portion of the fish's jaw. Fishing regulations with minimum size limits and catch and release fishing results in anglers releasing far more fish than are harvested. Point penetration/embedment in the upper mouth area results in much easier hook removal and greatly reduces the probability of injuring the fish.

Unfortunately, with the majority of jigs available today, this desired upright position is often difficult, if not impossible, to consistently maintain. Improperly balanced jigs or jigs which incorporate planing surfaces or bulbous appendages to impart special desired actions to the lure often perform erratically and will tumble, rotate or spiral about the line axis which, in turn, result in twisted lines and improper lure presentation. The results of improper presentation are hook embedment in areas other than the fish's upper jaw increasing the probability of injuring the fish, difficult hook removal and increased incidents of snagging on underwater obstacles. The type and configuration of the hook and the shape, weight and location of the body cast around the hook are all distinguishing features that determine how a jig will be categorized and how it may be expected to perform during any fishing situation.

In order to accurately predict a lure's performance, an initial evaluation that determines static balance is required. The traditional method assumes the lure to be suspended on a vertical line with the lure motionless. Standard, center and forward balanced are terms most often used to categorize jigs analyzed in this manner. Tackle manufacturers also often use these terms when describing their product. Standard and center balanced jigs incorporate a hook described as a shank bent down type. The hook has a short section of the shank behind the eye bent towards the hook point at an angle of approximately 90°. A ball or egg-shaped weighted body is cast about the shank in the proximity of the radius point of the 90° bend in the shank placing the center of gravity of the lure at or near the hook bend radius point. Suspended on a vertical line, the weighted body which counterbalances the weight of the hook bend results in the main shank presented horizontally and at an approximate 90° angle to the line. During casting, retrieving, trolling or allowing the lure to sink on a slack line, external forces acting upon the jig body are introduced which upset this equilibrium resulting in the lures rotating about the line axis which, in turn, results in twisted lines and improper lure presentation. These types are primarily used for vertical presentations or very slow retrievals.

In an effort to minimize this erratic behavior and provide jigs suitable for casting and retrieving at greater speeds, jigs described as forward balanced, have been introduced.

These types incorporate hooks with 45° to 60° eye bends and elongated bodies cast onto the shank behind and below the eye placing the center of gravity behind the eye bend radius point and farther back along the main shank. When suspended on a vertical line, the main shank hangs at an angle of approximately 45° to the line. Due to the eye being located at the front, these types also referred to as banana jigs, are better suited for horizontal retrievals. The main disadvantage of these types is the result of the larger bodies which must be used to adequately cover the hook and hook eye bend near the eye. The excessive weight and rearward center of gravity requires relatively fast retrieval speeds to prevent the lure from dragging along the bottom. When allowed to sink on a slack line, this tail heavy jig will descend point bend first and will rotate or tumble again resulting in twisted lines and improper lure presentation.

Recently, a number of lighter weight types have been introduced which are described as having weight centered qualities. Hooks configured with 10° to 30° eye bends are utilized and when suspended on a vertical line, the hook shank is presented at an angle of approximately 10° to 20° to the line axis. These types could be considered as a forward balanced variation, however, many manufacturers now deviate from the vertical line method of analysis and have elected to describe these types by the attitude the lure assumes when retrieved horizontally. The center of gravity of these types is still located behind the eye bend radius point but with additional weight distributed below the hook shank. When retrieved horizontally, the jig is presented with the hook shank horizontal. Jigs such as the Slow Poke™ by Bait Rigs, Weed Weasel™ by Northland Tackle and Winged Warrior™ by System Tackle typify types available within this group.

Saucer-shaped bodies, elongated oval bodies, bulbous appendages or flat planing surfaces are often utilized which are claimed to enhance horizontal stability and introduce special actions. Unfortunately, however, in many instances these attributes become a detriment to proper lure presentation unless the lures are fished at very specific speeds or with special presentation techniques. Deviating from specific presentation techniques, these types often perform more erratically than the standard, centered and forward balanced types previously described.

Until now, prior art lacks the combination of hook configuration, body shape and weight distribution for consistent presentation in the desirable upright position.

### SUMMARY OF THE INVENTION

Several objects and advantages of the invention are as follows:

(a) provide a lure which will maintain the desired hook upright attitude over a far greater range of retrieval speeds;

(b) provide a lure that does not require a special technique to be used effectively;

(c) provide a lure that will not tumble, spiral or rotate when allowed to sink on a slack line;

(d) provide a lure which will not tumble, spiral or rotate when airborne during casting;

(e) provide a lure that is less likely to snag on underwater obstacles such as weeds, branches, rocks, etc.;

(f) provide a lure which can be used effectively with a greater variety of artificial dressings without adversely effecting balance or presentation;

(g) provide a lure which can be used effectively with a greater variety of live bait;

(h) provide a lure with a body and hook configuration which will assure the greatest incidence of hook point embedment into the upper part of the fish mouth;

(i) provide a lure with minimum amount of weight required to achieve proper presentation;

(j) provide a lure with radiused surfaces which provides better paint adhesion and less incidence of paint chipping;

(k) provide a lure with an optimum distance between the eye and point while still maintaining balanced qualities;

(l) provide a lure whereby the knot is protected to a greater degree from cutting by the fish's teeth or abrasion from underwater obstacles;

(m) provide a lure whereby the body shape and weight can be made proportional to a greater variety of hook types and sizes.

The present invention relates to a jig consisting of a specifically shaped body with specifically located weight distributed along a specifically shaped hook establishing a specific center of gravity.

In one aspect of the invention, a fishing jig includes a fish hook of integral construction with a center axis having a hook curved trailing extremity with a hook point, a straight hook shank extending forwardly from the hook curve, and an eye bend extending forwardly and upwardly at an eye bend radius point at an angle of substantially 20° relative to the axis of the hook shank, and terminating in a line-attachment eye leading extremity. The fishing jig further includes a weighted metal body connected and distributed symmetrically along the hook shank and eye bend. The body has a mass distribution which is greater below the center axis of the hook than above the center axis of the hook by creating a wedge on a lower portion of the body that substantially counterbalances the weight of the hook curve and the hook point. A center of gravity is defined above the wedge at substantially the eye bend radius point such that, when pulled through water, the jig assumes an upright position in which the hook shank is maintained in a substantially horizontal attitude. The hook point lies in an uppermost position relative to the hook shank such that the jig will not tumble, spiral or rotate when attached on a fishing line.

The eye bend radius point is located behind the eye a distance of approximately one-quarter of the overall length of the hook. The metal body includes a spherical mass distributed about the hook shank and the eye bend radius point. A concave frontal area extends integrally and forwardly from the spherical mass and surrounds the eye bend. A concave shank collar extends integrally and rearwardly from the spherical mass, and surrounds the hook shank. A bait collar extends rearwardly from the shank collar and surrounds the hook shank. A lower portion of the spherical mass carries the counterbalancing wedge. The spherical mass has a diameter that is approximately one-half of a vertical distance between the hook shank and the hook point.

In certain embodiments of the fishing jig, the bait collar has an outwardly flaring rim on the rearward side thereof that joins the shank collar. The shank collar is tapered and the bait collar has a conical portion. The distance from the eye to the bait collar rim is approximately one-half the overall length of the hook. The shank collar where it meets the bait collar rim has a diameter substantially three times the diameter of the hook shank. A rubber weed guard extends rearwardly from the metal body toward the hook point. In another embodiment, a wire guard extends between the metal body and the hook point. In other embodiments, a shank collar is formed with ridges and the bait collar is barbed. The shank collar is cylindrical and the bait collar has a diameter larger than the shank collar. In further embodiments, the bait collar is barbed, and the frontal area of the shank collar has progressively tapering external surfaces.

### BRIEF DESCRIPTION OF THE DRAWINGS

The drawings illustrate the best mode presently contemplated of carrying out the invention.

In the drawings:

FIG. 1 is a side view of a streamlined, counterbalanced fishing jig embodying the present invention;

FIG. 2 is a top view of FIG. 1;

FIG. 3 is a front view of FIG. 1;

FIG. 4 is a rear view of FIG. 1;

FIG. 5 is a side view showing a first alternative embodiment of the fishing jig with a vertical hook eye parallel to the vertical hook bend;

FIG. 6 is a side view of a second alternative embodiment of the fishing jig showing a straight or cylindrical shank collar;

FIG. 7 is a side view of a third alternative embodiment of the fishing jig showing a straight or cylindrical shank collar with ridges or ribs formed therein;

FIG. 8 is a side of a fourth alternative embodiment of the fishing jig showing a shank collar with a barbed bait collar;

FIG. 9 is a side view of a fifth alternative embodiment of the fishing jig showing a ball type bait collar;

FIG. 10 is a side view of a sixth alternative embodiment of the fishing jib showing a slightly heavier embodiment with straight surfaces;

FIG. 11 is a side view of a seventh alternative embodiment of the fishing jig with a flexible weed guard; and

FIG. 12 is a side view of an eighth alternative embodiment of the fishing jig with a wire weed guard.

DETAILED DESCRIPTION OF THE INVENTION
LIST OF DRAWING REFERENCE NUMBERS

| | |
|---|---|
| 8 | Fishing jig |
| 10 | hook |
| 10a | hook eye |
| 10b | eye bend |
| 10c | eye bend radius point |
| 10d | hook shank |
| 10e | hook curve |
| 10f | hook point |
| 12 | metal body |
| 12a | spherical body mass |
| 12b | frontal area (concaved) |
| 12c | counterbalancing weight wedge |
| 12d | shank collar (concaved) |
| 14 | bait collar |
| 14a | bait collar rim |
| 14b | conical portion of the bait collar |
| 16 | center of gravity |

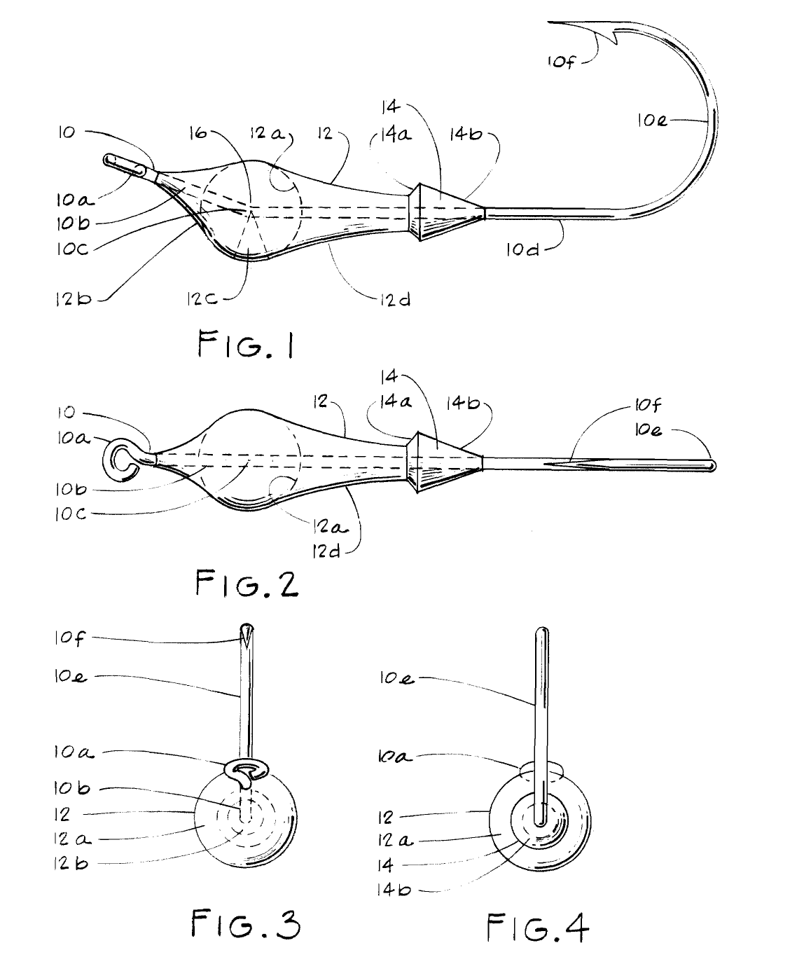

A preferred embodiment of the fishing jig 8 is illustrated in FIGS. 1-4 and shows a fish hook 10 with a metal body 12 cast about the hook 10. The hook 10 is a light Aberdeen ringed hook with an eye 10a adapted to be attached to a fishing line, and a short section attached to the eye 10a and referred to as the eye bend 10b. The eye bend 10b is bent towards the hook point 10f of a hook curve 10e at an angle of approximately 20° to a straight hook shank 10d. The eye 10a forms a leading extremity of the jig 8, while the hook curve 10e forms a trailing extremity. The hook point 10f may be barbed or barbless. An eye bend radius point 10c is located behind the eye 10a a distance of approximately one-quarter of the total hook length.

The metal body 12 incorporates an integral cast or formed metal mass such as constructed of lead or the like, constituting four specific areas, namely, a spherical body mass 12a, a frontal area 12b, a counterbalancing wedge 12c, and a shank collar 12d. The diameter d₁ of spherical body mass 12a is one-half of the distance d₂ measured vertically between the hook shank 10d and the hook point 10f. The concave frontal area 12b is concentric with and surrounds the hook eye bend 10b. The concave shank collar 12d is concentric and surrounds the hook shank 10d and terminates at an outwardly flaring rim 14a of a bait collar 14 having a conical portion 14b that surrounds shank 10d. The distance from the eye 10a to the bait collar rim 14a is one-half of the average length of the hook. The diameter of the shank collar 12d where it meets the bait collar rim 14a is approximately three times the diameter of the hook shank 10d. All parts of the body 12 are cast symmetrically about the center line of the hook 10. This results in a decrease in body mass above the hook shank centerline and an increase in the body mass below the hook shank centerline thereby creating the counterbalancing weight wedge 12c. The wedge 12c counterbalances the hook curve 10e and point 10f. The weight distributed along the hook shank 10 places the center of gravity 16 of the lure at or near the eye bend radius point 10c.

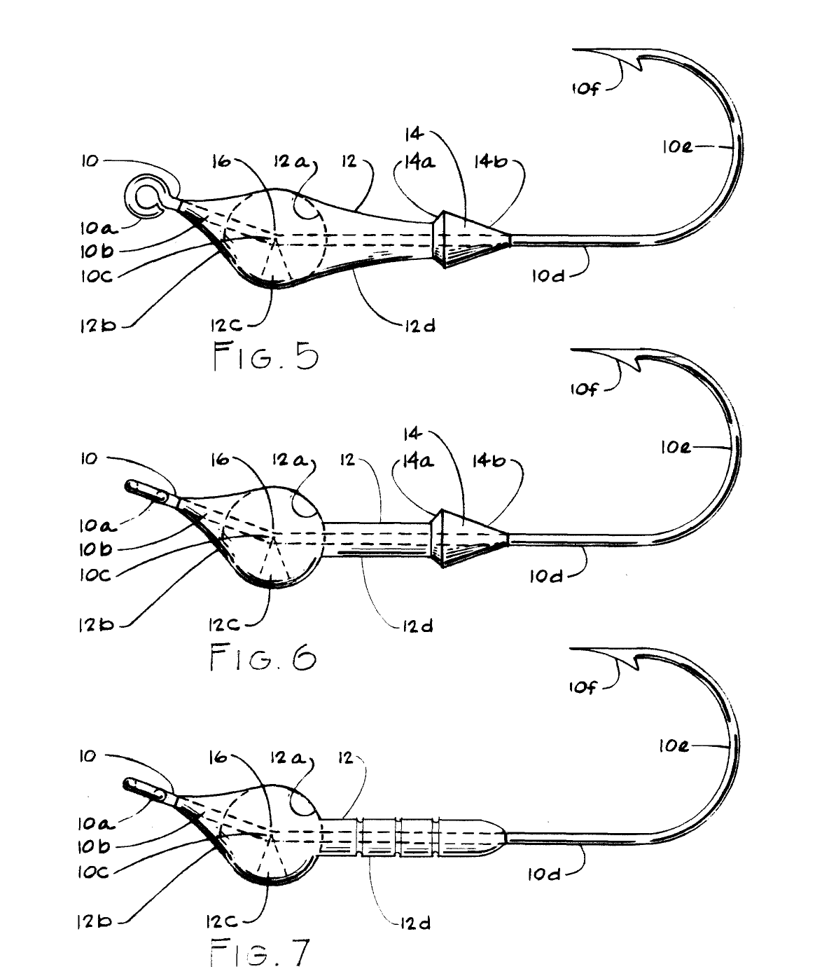

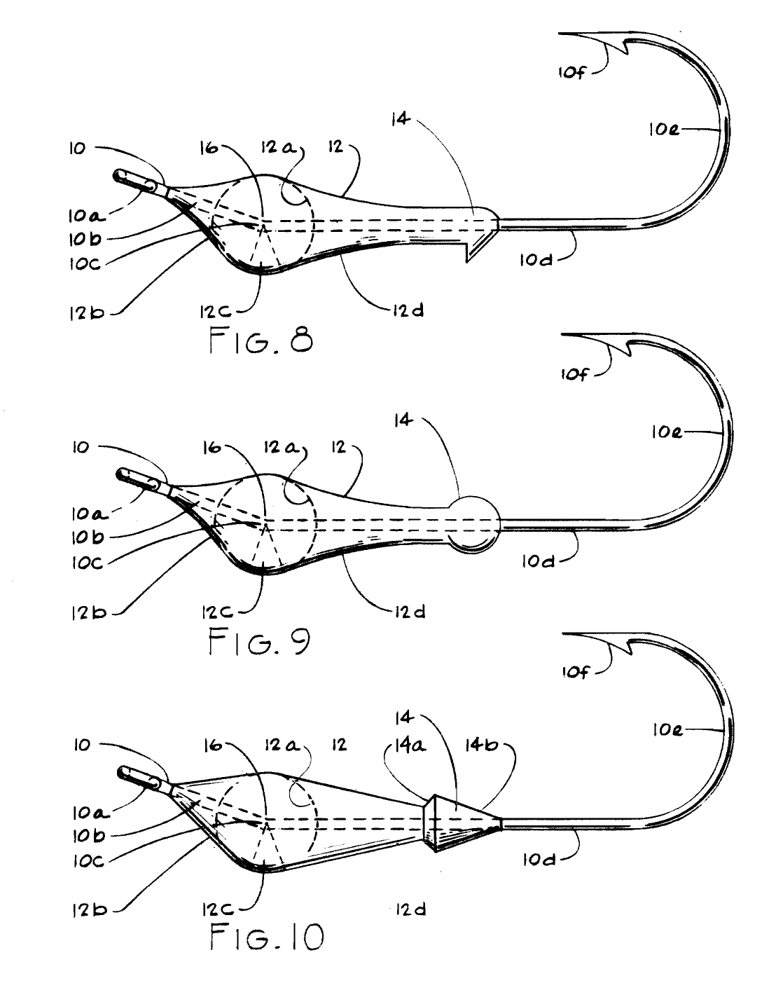

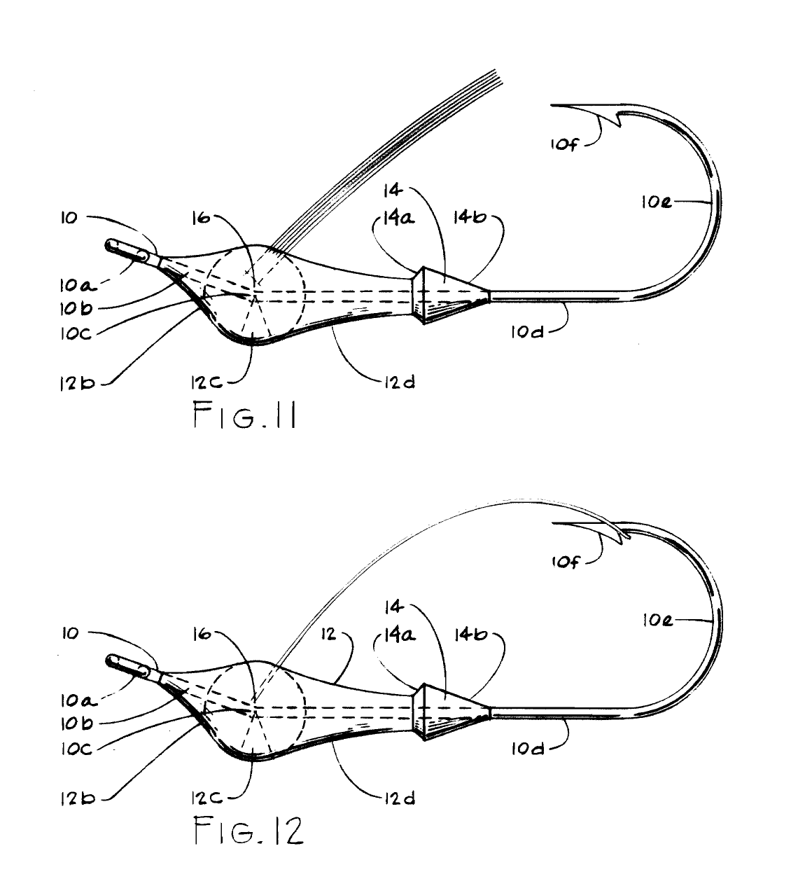

There are various possibilities to hook configurations and body shapes which may be incorporated or used alternatively which will not appreciably affect the performance or balance of the lure. FIG. 5 shows a side view of the hook eye parallel to the hook curve 10e. FIG. 6 shows a side view with a generally cylindrical shank collar 12d having external surfaces parallel to the hook shank 10d. FIG. 7 is a side view that shows a straight cylindrical shank collar 12d. FIG. 8 is a side view that shows a barbed bait keeper 14. FIG. 9 is a side view that shows a ball type bait collar 14. FIG. 10 is a side view that shows a heavier body 12 cast concentrically about the centerline of the hook without concave surfaces, but with progressively tapering external surfaces. FIG. 11 is a side view that shows a flexible weed guard. FIG. 12 shows a wire weed guard.

A hook configuration, body, shape and weight distribution are combined to provide a lure with a specific center of gravity. These attributes provides a jig lure that will react consistently with forces acting upon the body to achieve and maintain the desirable upright position.

When vertically suspended, the shank 10d will assume an angle of approximately 18° to vertical. When airborne during casting, the combination of line drag and the additional body weight behind the center of gravity 16 results in the jig sailing hook curve 10e first. The weight wedge 12c counterbalances the hook curve 10e thereby presenting the jig 8 in the desirable upright position even when airborne. When the lure enters the water at the termination of the cast and is allowed to sink on a semi-taut line to a desired depth, the force of the line drag combined with the gravitational force and the force exerted by the water along the lower surfaces of the body 12 and shank collar 12d results in the lure sinking with the hook shank 10d nearly horizontal. The weighted wedge 12c counterbalances the hook curve weight and the jig 8 is presented in the desirable upright position.

If a faster rate of descent is desired, the angler strips additional line from the reel allowing the lure to freefall. As the lure freefalls, gravity pulls the eye 10a downward rotating the body horizontally about the center of gravity. Resisting forces now introduced on the frontal area 12b will then counteract the gravitational force and push the eye 10a upwards with the lure again assuming the desirable hook shank horizontally. The weight wedge 12c again assures that the lure maintains the desired upright position.

Where retrieval is commenced, the pulling force exerted through the eye 10a, the gravitational advantage of the weight wedge 12c below the center of gravity and the resistant horizontal forces acting upon the frontal surfaces 12b of the body will result in the hook shank 10d rotating upwards to a nearly horizontal attitude. The lure now in a state of horizontal equilibrium will remain so over a greater range of retrieval speeds, and again, due to the weight wedge 12c which counterbalances the hook curve 10e, the lure will maintain the desirable upright position.

Additional forces that can act upon the body 12 are those that may be encountered when the jig 8 is fished in a current such as encountered during river fishing. The side forces are negliable due to the lure's radiused surfaces and the weighted wedge 12c will maintain the lure's balance and equilibrium and the lure remains in the upright position.

In conclusion, the reader will see that the invention is a jig lure with superior balance allowing the angler to present the lure in the desirable upright position during any fishing situation that may be encountered.

It provides a jig lure which is much easier to use successfully for both beginners and experienced anglers.

It provides a jig lure which allows use of larger or smaller hooks with bodies made proportioned to the hook selected.

It provides a jig lure which when retrieved or trolled will not rotate about the line axis causing twisted lines.

It provides a jig lure which will not overturn when retrieved through a cross current.

It provides a jig lure that when a fish strikes will provide a greater frequency of point embedment in the upper part of the fish's jaw resulting in easier hook removal.

It provides a jig lure which is less likely to cause injury to fish.

It provides a jig lure which will reduce incidents of snagging.

It provides a jig lure which can be cast with a variety of materials.

It provides a jig lure which can be used effectively with a greater variety of permanent dressings.

It provides a jig lure which can be used effectively with a greater variety of live bait.

It provides a jig lure which can be used effectively with a greater variety of artificial dressings.

It provides a jig lure which is easier to paint due to its radiused surfaces.

It provides a jig lure with the optimum space between the hook eye and the point.

It provides a jig lure with optimum hook gap (verified distance between eye and point).

It provides a jig lure with a precisely located center of gravity.

While the invention has been described with reference to a preferred embodiment, those skilled in the art will appreciate that certain substitutions, alterations and omissions may be made without departing from the spirit thereof. Accordingly, the foregoing description is meant to be exemplary only and should not be deemed limitative on the scope of the invention set forth with the following claims.

I claim

1. A fishing jig comprising:
a fish hook of integral construction with a center axis having a hook curve trailing extremity with a hook point, a straight hook shank extending forwardly from the hook curve, and an eye bend extending forwardly and upwardly at an eye bend radius point at an angle of substantially 20° relative to the axis of the hook shank, and terminating in a line-attachment eye leading extremity, and
a weighted metal body connected and distributed symmetrically along the hook shank and the eye bend, the body having a mass distribution which is greater below the center axis of the hook than above the center axis of the hook by creating a wedge on a lower portion of the body that counterbalances weight of the hook curve and the hook point,
whereby a center of gravity is defined above the wedge at substantially the eye bend radius point such that, when pulled through water, the jig assumes an upright position in which the hook shank is maintained in a substantially horizontal attitude, and the hook point lies in an uppermost position relative to the hook shank such that the jig will not tumble, spiral or rotate when attached on a fishing line.

2. The fishing jig of claim 1, wherein the eye bend radius point is located behind the eye a distance of approximately one-quarter of an overall length of the hook.

3. The fishing jig of claim 1, wherein the metal body includes
(a) a spherical mass distributed about the hook shank and the eye bend,
(b) a frontal area extending integrally and forwardly from the spherical mass and surrounding the eye bend,
(c) a shank collar extending integrally and rearwardly from the spherical mass, and surrounding the hook shank, and
(d) a bait collar extending rearwardly from the shank collar and surrounding the hook shank.

4. The fishing jig of claim 3, wherein a lower portion of the spherical mass carries the counterbalancing wedge.

5. The fishing jig of claim 3, wherein the bait collar has an outwardly flaring rim on a rearward side thereof that joins the shank collar.

6. The fishing jig of claim 3, wherein the shank collar is tapered.

7. The fishing jig of claim 3, wherein the frontal area is tapered.

8. The fishing jig of claim 3, wherein the bait collar has a conical portion.

9. The fishing jig of claim 5, wherein the distance from the eye to the bait collar rim is one-half the overall length of the hook.

10. The fishing jig of claim 5, wherein the shank collar where it meets the bait collar rim has a diameter substantially three times a diameter of the hook shank.

11. The fishing jig of claim 1, wherein the spherical mass has a diameter that is one-half of a vertical distance between the hook shank and the hook point.

12. The fishing jig of claim 1, wherein a flexible weed guard extends rearwardly from the metal body towards the hook point.

13. The fishing jig of claim 1, wherein a wire guard extends between the metal body and the hook point.

14. The fishing jig of claim 3, wherein the shank collar is concavely and progressively tapered down from the spherical mass of the body to the point where it meets the bait collar.

15. The fishing jig of claim 3, wherein the frontal area is concavely and progressively tapered down from the spherical mass of the body to a termination point on the hook shank near the hook eye.

16. The fishing jig of claim 3, wherein the shank collar is cylindrical.

17. The fishing jig of claim 3, wherein the shank collar is formed with ridges and the bait collar is barbed.

18. The fishing jig of claim 3, wherein the shank collar is cylindrical and the bait collar is ball shaped with a diameter larger than the shank collar.

19. The fishing jig of claim 3, wherein the bait collar is barbed.

20. The fishing jig of claim 3, wherein the frontal area and the shank collar have progressively tapering external surfaces.
